(19) United States
(12) Patent Application Publication
(10) Pub. No.: US 2023/0349557 A1
(43) Pub. Date: Nov. 2, 2023

(54) SYSTEMS AND METHODS FOR GRILL SMOKER OR INDIRECT COOKING CONVERSION AND AIRFLOW REDIRECTION DURING SMOKING OR INDIRECT COOKING

(71) Applicant: HERBERT MARVIN BEDINGFIELD, JR., SAVANNAH, GA (US)

(72) Inventor: HERBERT MARVIN BEDINGFIELD, JR., SAVANNAH, GA (US)

(21) Appl. No.: 18/310,420

(22) Filed: May 1, 2023

(30) Foreign Application Priority Data
May 1, 2022 (US) 63337143

(51) Int. Cl. F24B 5/06; A47J 37/07; A23B 4/052

(52) U.S. Cl. CPC F24B 5/06; A47J 37/0704; A47J 37/0786; A23B 4/052; A47J 2037/0795

(57) ABSTRACT

Improvements regarding aspects of cooking and/or grilling are described, including a grill insert for a grill having a removable lid, the insert facilitating redirection of airflow from normal grill path(s) of up and out of the grill lid to instead flow at least partially down and over or around an indirect grill cooking surface and out the side of the insert.

### CROSS-REFERENCE TO RELATED APPLICATIONS

This application claims priority to U.S. Provisional Application Ser. No. 63/337,143, filed May 1, 2022, entitled “Systems and Methods for Grill Smoker or Indirect Cooking Conversion and Airflow Redirection During Smoking or Indirect Cooking”, the disclosure of which is incorporated herein in its entirety.

### FIELD

The present technology is directed to a grill conversion apparatus, system and method for conventional grills to convert such conventional grills to a smoker and/or an indirect food cooker, as well as to related redirection of airflow during cooking to direct such airflow at least partially away from the existing grill airflow path or paths and at least partially across the top of or down and over the cooked food in order to provide better end result.

### BACKGROUND

The present disclosure describes proposes various improvements regarding aspects of a system, method and apparatus for grill conversion for smoking and/or indirect cooking of food, including at least partial redirection of airflow during cooking to direct such airflow at least partially away from the existing grill airflow path or paths and at least partially across the top of or down and over the cooked food in order to provide better end result.

A Weber™ grill comes in a variety of sizes and has a range of costs related thereto. The variety, sizes and costs of their charcoal grills may be found at the following link https://www.weber.com/US/en/grills/charcoal-grills/. Their most common sizes relate to circular charcoal grills at 14 inches (″), 18″, 22″, 26″ and 37″, in a circular lid to bowl configuration and with a removable lid (rather than a hinged lid). These grills include an adjustable lower vent for inlet air at the base of the bowl and an upper vent/damper offset partially on one side of the upper dome lid. During cooking, the lid may be rotated to different positions in order to at least partially direct airflow, by virtue of it's offset upper damper location, as desired, from the charcoal to an upper portion of the dome lid, depending on its rotated position. For example, on a 22″ Weber™ Kettle, the upper vent is offset approximately 6″ from center.

Weber™ also makes a “Smokey Mountain Cooker Smoker” in a variety of sizes, also holding to the 14″, 18″ and 22″ circular formats. These smokers include a fuel door in a cylindrical piece in order to access and/or add to charcoal fuel provide therein. For these models, the lower (bowl) vent is somewhat offset from center as well. Otherwise, the design is similar to exterior of the Weber™ Kettle designs. At one point, Weber™ also sold a conversion kit for the Weber™ Kettles to include an ring insert, which also included a fuel access door, a fire ring and other accessories.

Traditional kettle conversion enthusiasts have designed mechanisms for smoking within a kettle, including use of paving stones on the lower grate to create a hot coal zone and a cool side, with or without use of foil or other blocking areas at the bottom of the cool zone to create that smoking and/or indirect cooking space on the lower grate itself, with the dome lid on and angled as desired to adjust the upward airflow (e.g., for a 22″ Kettle, around that 6″ radius arc, though this can be somewhat of an inexact cooking science apart from simply opposing the hot/coal zone with the dome lid damper six inches offset from center. On a 22″ Kettle, this creates a flow path from the hot coals, upwards, at least partially over the top portions of the food lying on the lower grate in the cool zone, and again, upward and out of the top of the Kettle dome six inches from center (or less and on a different vector if the lid is rotated a bit in either direction).

Other companies have also attempted to create smoker compatible products relative to Weber™ Kettles or other similar company designs. One such product is the Smokenator 1000, which is identified at the following link https://www.kettlepizza.com/product/smokenator-1000/. This product was wholly inserted into a portion of the grill; and like the brick or pavers method, creates a hot zone and an indirect cooking zone (on the bottom grate of the Kettle).

SNS Grills™ also creates a “Slow 'N Sear” product that sits on the lower grate and incorporates a hot zone and (shielded either just by metal or by metal and a liquid reservoir) an indirect zone). An example of this product may be found at https://snsgrills.com/products/slow-n-sear-deluxe.

Any of the above three designs would be compatible with the present disclosure.

Some companies have also designed kettle inserts, much like the Smokey Mountain Conversion. For example, like Weber™, Cajun Bandit™ developed a smoker conversion kit that includes a continuous outer Kettle extension ring (without a fuel access door), a fire ring and other accessories (see https://cajunbandit.com/product/cajun-bandit-22-5-kettle-smoker-conversion-kit/). Barbecue Stacker™ did something similar that also included a rotisserie (see http://www.barbecuestacker.com).

[SMOKESTACK] BBQ™ provides a bypass system as an adapter for a Kettle that has a particular design allowing feeding of fuel from the ring down into a lower portion of the kettle, with a “bypass” mode during ignition of wood for a wood burning Kettle conversion (wood when fed into a fire initially burns with “black smoke”). This apparatus operates with a control feed/exhaust in order to direct smoke completely away from the cook chamber in a first position, and with a cook mode in a second position to seal that opening to then allow non-black smoke into the chamber and up through a water bath and again upwards through the regular Kettle dome vents (see https://smokestack-bbq.com/) during the cook phase.

What is needed in the art is are systems, apparatuses and methods for grill conversions that improve upon prior designs by at least partially redirecting airflow during cooking of food beyond the established path(s) of the grill itself for the benefit of smoking and/or indirect cooking.

### SUMMARY

The techniques of this disclosure generally relate to various improvements regarding aspects of grilling/cooking, with conversion of an existing grill having a lower body including a lower vent, an upper, removable lid including an upper damper, at least two cooking grates and an outer geometry defined by the shape of the lower body and the upper, removable lid, the conversion including an compatible body insert between the lower body and the upper, removable lid, the that includes a side exhaust vent that acts, alone or in conjunction with the upper damper to redirect cooking airflow that is configured to already flow from a hot cooking zone up to the lid damper to instead flow down from the grill headspace across an indirect cooking zone and out of the side exhaust vent.

In further exemplary embodiments, moisture from the hot cooking zone (e.g., from a reservoir in or near that zone) and the lid (e.g., passed up from an indirect heat zone via a moisture pan or from the food itself) also passes at least partially over the indirect cooking zone and out of the side vent rather than wholly up and through the lid damper.

In additional exemplary embodiments, the compatible body insert includes at least one grate support. In further exemplary embodiments, the at least one cooking grate support is positioned at least partially over or above an opening of the side vent, such that air flow passes over and at least partially around or past edges of the cooking grate as the air flows from the hot zone and/or lid to the side vent.

In additional exemplary embodiments, the compatible body insert includes plural cooking grate supports, or at least one height adjustable grate support, such that the degree of airflow redirection and concurrent airflow over the indirect cooking zone provided by the side vent may be adjusted. In further exemplary embodiments, such height adjustment is accessible from the interior or exterior of the compatible body insert.

In further exemplary embodiments, the side exhaust vent is configured with an aperture portion that sits at least even with or partially below a fixed or movable elevated grate (e.g., those resting on a lower bowl grate and configured to elevate above that lower bowl grate to a certain height) such that air flow passes over and at least partially around or past side edges (height-wise) of the elevated grate as the air flows from the hot zone and/or lid to the side vent. Such embodiments (or designs allowing for rotation or movement of a cooking grate) also allow for spacing of or rotation of cooking surfaces relative to the side vent for further tailored airflow or moisture exposure effect.

In exemplary embodiments, the compatible body insert comprises a kettle insert having a predetermined circular geometry. In exemplary embodiments, the kettle insert is circular. In other exemplary embodiments, the kettle insert is 14″ in diameter. In other exemplary embodiments, the kettle insert is 16″ in diameter. In other exemplary embodiments, the kettle insert is 18″ in diameter. In other exemplary embodiments, the kettle insert is 22″ in diameter. In other exemplary embodiments, the kettle insert is 26″ in diameter. In other exemplary embodiments, the kettle insert is 37″ in diameter.

In additional exemplary embodiments, the compatible body insert is circular/cylindrical, compatible with a kettle grill having a predetermined diameter and includes upper and lower gaskets configured to seal with the kettle lower bowl and upper, removable lid.

In additional exemplary embodiments, the compatible body insert is circular, compatible with a kettle grill having a predetermined diameter, with a side vent that protrudes from a compatible circular side vent base. In further exemplary embodiments, the vent has a protruding vent tube. In further exemplary embodiments, the protruding vent tube has a slide cap for selectively opening or closing the side vent. In further exemplary embodiments, the protruding vent tube includes at least one bend, e.g., including an upward facing vent tube portion capped by an adjustable slide cap configured to selectively close the vent tube.

In further exemplary embodiments, the compatible body insert includes at least one handle configured to allow removal thereof from the grill. In exemplary embodiments, the at least one handle protrudes from the compatible body insert and includes a non-heat conducting material compared to traditional heat conductors (e.g., wood, elastomer, etc.) such that a hot compatible body insert may be removed during cooking or rotated during cooking to position the side vent relative to the hot cooking zone as may be desired to tailor airflow up from the hot cooking zone and from the lid (and any at least partially open or fully closed dampers thereon) across the indirect cooking zone and out of the side vent. In further exemplary embodiments, the compatible body insert includes at least two handles to permit more stable removal and facile reinstallation of the insert during cooking/refueling of the cooking zone/adjustment of grates or cooking elements/etc.

In further exemplary embodiments, the compatible body insert comprises multiple parts that are configured to be assembled via fasteners. In other embodiments, such fasteners also connect to one or more compatible body insert handles, as described above.

In further exemplary embodiments, the side vent is provided with a closable member (e.g., the slide cap mentioned above) to control cook temperature as well as airflow, alone or in conjunction with the upper lid damper and/or the lower body vent. In exemplary embodiments, all three air pathways from the exterior/interior of the grill can be used to tailor airflow over the indirect cooking zone. Additionally, all three can be used to regulate temperature. Also, all three can be used to control moisture flow over food situated on the indirect cooking zone.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a front perspective view of a kettle grill with an exemplary smoker insert, in accordance with exemplary aspects of the disclosure;

FIG. 2 is a perspective view of a portion of the grill and insert of FIG. 1, with the lid removed and the interior of the exemplary insert shown;

FIG. 3 is another perspective view of the grill insert of FIG. 1, further illustrating the direct and indirect heat zones;

FIG. 4 is another perspective view of the grill insert of FIG. 1, showing cooking on both direct and indirect zones; and

FIG. 5 is a perspective plan view of the interior wall of the indirect zone adjacent the side exhaust vent provided through the interior wall of an exemplary grill insert, with one or more grill support members provided to support a grill at least partially over or above the opening of the side exhaust vent.

### DETAILED DESCRIPTION

As we have noted, the present disclosure describes various improvements regarding aspects of grilling and/or cooking, including with regard to apparatuses, systems and methods for redirecting existing airflow path(s) using an insert.

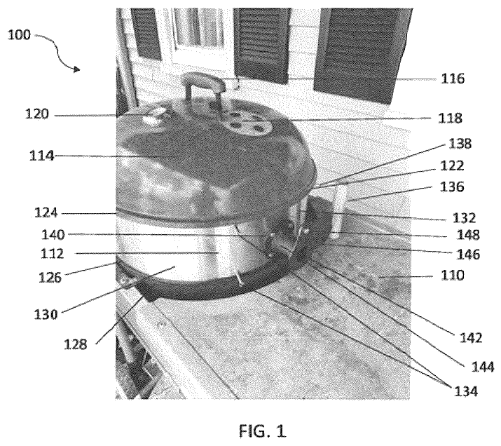

FIG. 1 illustrates a first exemplary embodiment, showing a 22″ Weber™ Performer Grill, shown generally at 100 (which includes an attached cart 110) also including an exemplary compatible body insert 110. The exemplary (in this case a kettle) grill includes (as part of the original grill), a removable lid 114, a lid handle 116, a rotary damper 118, offset from the removable (dome) lid 114 by about 6″, a dome thermometer 120 and a circular lower perimeter edge 122, with a flare 124, configured to mate with a rim 126 of the lower bowl 128. While it is not visible in this figure, this particular kettle grill also has a lower flare recess interior of the rim 126 of the lower bowl 128.

Referring still to FIG. 1, insert 112 is illustrated as an exemplary multi-part configuration, with at least first 130 and second portions 132 joined by one or more fasteners 136. In exemplary embodiments, fasteners 136 may also, as shown, extend beyond the surface of the insert 112 such that it/they form(s) a resting place against one or both of the lower perimeter edge 122 of the lid 114 and/or the rim 126 of lower bowl 128.

The insert 112 is illustrated nested within the flare 124 of the removable lid 114 and the lower flare of the rim 126 of the lower bowl. As will be shown below, in exemplary embodiments use of a gasket, e.g., a high temperature gasket material for grills on one or both of the upper and lower edges of the insert or on the surfaces of the grill provides a relatively sealed configuration for that (removable) mating.

Exemplary handle 136 is illustrated as being attached by fastener 138, the handle being wood. For this particular embodiment, handle 136 is also attached by another (lower) fastener 138, though the side exhaust vent 140 (hereinafter “side vent” or “exhaust vent”) blocks that view.

Exemplary side exhaust vent 140 is illustrated as being attached to the insert 112 (in this case the kettle is circular), so the vent 140 is attached to the insert via a complementary base shape (e.g., as a partially rounded base shape), which can be integral to, screwed to, welded to, etc., the material of the insert 112. The insert also includes a vent outlet 142, which may or may not (i.e., not connected if it is close to the insert/integral to the base) also be connected to the base of the vent 140 via a vent air extension portion 144, having a length away from the insert 112. The shape of that vent air extension portion 144, should it be included may be straight and tubular (as shown) or any other desired shape or configuration, e.g., as an elbow with an upward facing exhaust, as a curved member, etc.

Additionally, exemplary vent 140 includes a closing member 146, in this case closed via a pivot over a tensioned screw 148 (which may be a tightly held member pushable for increments between fully closed and fully open positions relative to the vent outlet 142).

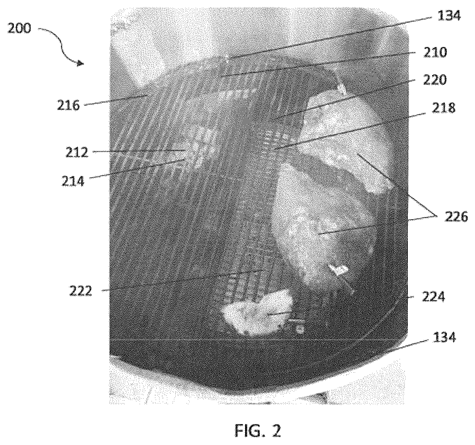

FIG. 2 illustrates generally at 200, an exemplary insert grate 210, a hot zone 212, with charcoal 214 and/or wood therein, with this grate including a hinged component 216 to allow fuel feeding. FIG. 2 also shows an exemplary smoking or indirect zone 218 that extends from the base grate 220 and/or drip pan 222 (which can help restrict airflow from below the smoking/indirect zone) thereon, to an area above the insert grate, or as will be shown below, a possible movable grate insert elevated above the base grate 220 or drip pan 222). In this illustrated exemplary embodiment, the cooking area within the smoking/indirect zone 218 is above the insert grate 210 that is nested on the upper inner fasteners 134 of the insert. In this case, the airflow provided by the grill directs the lower air from the hot coals 214 of the hot zone 212 upwards towards the (spaced apart) grill dome, which cannot vent (or at least fully vent) the air via a closed (or at least partially closed) damper 118 and back down over the food (e.g., see the pineapple 224 and chicken breasts 226) to the side vent, which in this case is well below the cooking grate on the smoking/indirect zone 218.

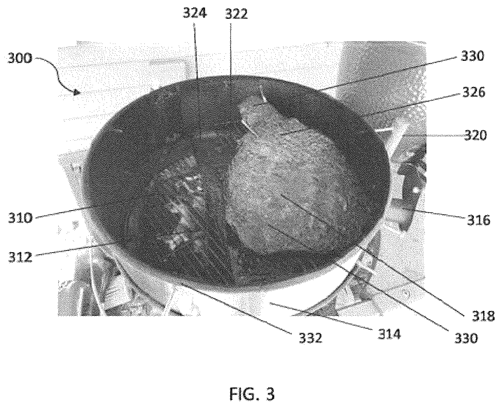

FIG. 3 illustrates an exemplary embodiment with a lower grate 310, covering a hot zone 312 (optionally with an openable grate portion for feeding fuel to the hot zone). In this case, the removable insert 314 is movable around the circumference of the shown exemplary kettle; and the side vent 316 and is positioned slightly off center of the opposite side of the hot zone to create an airflow path over a portion of the positioned packer brisket 318 (note, that this can be adjusted at any time via use of handle(s) 320, e.g., to position the point, join between the point and flat, or flat closer to the vent 316). We also note that in this case, vent 316 is fully open.

Additionally, in exemplary embodiments where a movable elevated grill surface 322 is used, the elevated grill itself or any associated attached/elevated drip pans, e.g., drip pan 324, may be moved or positioned to adjust the position of the food (possibly without moving the insert 314) or to shield any portion or portions of the meat (e.g., by pulling drip pan slightly towards the hot zone 312) to tailor the cook and to adjust the airflow from the hot zone 312/coals up to the (exemplary) dome lit and down over the illustrated brisket to the side vent 316. In this example, good color/char 326 can be seen around the flat 328 as well as on the point 330 of the brisket 318 due to the airflow curving over the brisket to the side vent 316. Note that in this particular illustrated example, movable elevated grill surface 322 allows the brisket 318 to also be spaced a bit from the side vent 316, with attached drip pan 324 being extendable to also shield the brisket 318 a bit more from direct heat, promoting that up and over and out the side airflow that creates the nice cook. That being said, this could also be reproduced using movable shield elements on the cooking grill to adjust the difference/line between the hot zone 314 and an indirect zone 218, as well as upwards or downwards adjustable grates within the insert to fine tune the level of exposure of the cooking grate to the redirected air.

FIG. 3 also shows at least one exemplary gasket 332, provided around an upper periphery of insert 314 to provide sealing of airflow.

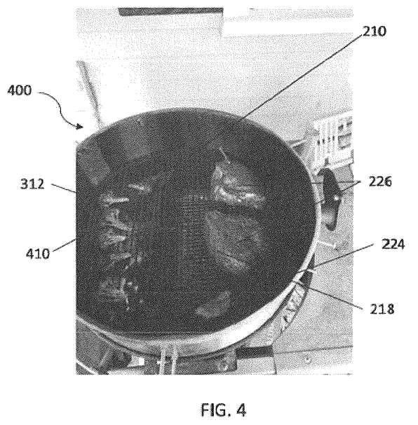

With further reference to FIG. 4, which shows a cooking evolution of the embodiment of FIG. 2 generally at 400, a full circle elevated insert cooking surface grate, such as 210 in FIG. 2 (or indeed use of plural movable elevated cooking grates, such as 322 in FIG. 3 or otherwise (e.g., half moon or quarter grate pieces that may be placed or removed)) allows for direct cooking over the hot zone 312 as well as for concurrent continual cooking over the smoking and/or indirect zone 218, with movement of heat (with the lid on) up and past the broccoli 410 (for direct heat cooking), to the lid and at least partially across and down over the chicken 226 (and pineapple 224), for continued indirect and/or smoked cooking. This also provides flexibility for cooking, where a side, such a charred broccoli, can be finished near the end of a planned slow cook such that they can be presented together. In the alternative, an elevated cooking surface/grate may be provided for the smoking and/or indirect side, and direct grilling may be done at a lower level, partway down to or on the lower grate.

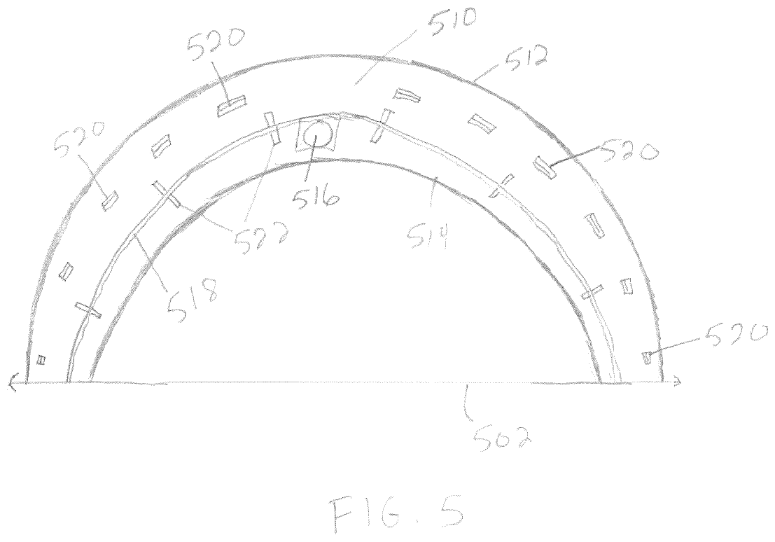

FIG. 5 is a top perspective view of one half of an exemplary circular/cylindrical kettle insert, shown generally at 500, bisected at line 502, with a cylindrical wall 510, upper and lower gaskets 512, 514 to provide a good seal between a kettle grill lid and a kettle grill bowl, and an internal portion of a side exhaust vent 516 positioned on a lower portion of the insert 500 (at least partially below illustrated exemplary insert grill/grate support members 518 (shown as a continuous support around the interior of the illustrated half of the kettle insert 500) and 520 (shown as plural grill/grate support tabs or channels, which may be the same or different lengths at least partially around the interior of the illustrated half of the kettle insert). The non-illustrated half of the insert 500 may mirror the illustrated exemplary grill support components or may include different grill support configurations (given that the non-illustrated half would rest over the hot zone of the grill, and thus may benefit from lower grill heights than would be provided over the illustrated/indirect zone).

Referring still to FIG. 5, any of the insert grill/grate support members 518, 520 may also include varying mechanisms to adjust height, e.g., the sliding tracks 522 shown with grill support member 518, which is configured to allow the grill height to be raised or lowered according to preference (note that the term “grill height” refers to the height(s) of the grill cooking surface(s), or grate(s)). The tracks 22 may include sliding support for the member 518 to allow adjustment of the entire member 518, with one or more locking members, such as wingnuts, set screws, etc., to finalize the position prior to loading it with food. Any of support members 520, should the kettle insert 500 be equipped with support members of that type in lieu of or along with support members of the type shown at 518, may also utilize height adjustment aspects described herein. We note that the tracks 522, in this illustrated exemplary embodiment, are configured to position the grill grate in one or more positions above the bottom of side exhaust vent 516, further facilitating the redirection of air flow over the food and out the side vent during indirect cooking or smoking.

Support members 518 and/or 520 may provide a simple ledge for grill grate support, or may be configured as a slotted (e.g., c-shaped) configuration to more securely hold a grate or to facilitate rotation of a grate provided thereon or therein, e.g., to have an upper half moon grate rotated so that part of the surface now rests higher up over the direct heat/hot zone.

As we have noted, cooking conditions can advantageously be tailored not just using internal components of an apparatus, system or method, but also using relative positioning of the three airways, inclusive of the bottom inlet (which is adjustable), the upper damper (in many cases a kettle dome damper) and the side vent, which in embodiments is movable, particularly in a kettle/circular configuration, as desired. In many instances, establishing operative temperatures can be done with the upper damper completely closed, with the lower vent open sufficiently to provide combustible air, and with the side vent open to provide the venting pathway (for both air and moisture). During use, it may be beneficial to open the dome damper slightly and/or adjust the positioning to produce more output, e.g., when coals burn down and before the grill is refueled, and/or to provide more aggressive heating to one or more portions of the cook surface (with the side vent still pulling down airflow over or across the indirect heat cooking surface). Additionally, where round kettles are used, the insert itself or supported grill grate(s) provided therein can be rotated (or in exemplary embodiments, raised or lowered via adjustment of the grill grate support member(s)) to provide airflow over select portions of cooking surfaces or cooking food to further tailer the cook.

Exemplary aspects described herein advantageously allow, where standard round kettles are used, an inexpensive insert that is configured to redirect the natural flow of exhaust, which for kettles is up and out, to instead provide for airflow, heat and moisture to flow back down from the headspace of the grill, over the top and/or sides of the food and out the side of the insert, providing an airflow path not previously used for kettle grills, which themselves are an inexpensive, commonly owned type of grill.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single apparatus for purposes of clarity, it should be understood that the techniques of this disclosure may be performed by a combination of the apparatus associated with, for example, a cooking device, system or method including described accessories or additional accessory cooking or airflow sensing devices, the latter being either single sensing devices or positioned (e.g., as part of temperature probes seen discretely in the brisket) separately over the cooking surface.

What is claimed is:

1. A grill system, comprising:
a kettle-style grill, including a kettle bowl and a kettle lid configured to seat onto or within the upper periphery of the kettle bowl, wherein the kettle bowl includes an air inlet in a lower portion of the kettle bowl and wherein the kettle lid includes an air outlet on an upper portion of the kettle lid, and further wherein the kettle bowl is configured to support at least one grill grate within the periphery of the kettle bowl; and
a kettle grill insert, the kettle grill insert comprising a wall having a cylindrical geometry, with a lower edge configured to seat onto or within the periphery of the kettle bowl, and an upper edge configured to engage a lower periphery of the kettle lid, wherein the kettle grill insert includes a side exhaust vent configured to draw grill gasses from an area within the kettle lid back down and out of the side of the kettle grill insert.

2. A grill system in accordance with claim 1, wherein the side exhaust vent is positioned at least partially through the lower half of the kettle grill insert.

3. A grill system in accordance with claim 1, wherein the kettle grill insert further includes at least one grate support surface provided over or above the side exhaust vent at least on the same side as the side exhaust vent.

4. A grill system in accordance with claim 3, wherein the at least one grate support surface is vertically adjustable.

5. A grill system in accordance with claim 2, wherein the kettle grill insert further includes at least one grate support surface provided on the upper half of the kettle grill insert and at least on the same side of the kettle grill insert as the side exhaust vent.

6. A grill system in accordance with claim 1, wherein the side exhaust vent includes an exterior vent pipe with a damper.

7. A grill system in accordance with claim 1, wherein the upper and lower edges of the kettle grill insert include sealing surfaces configured to prevent the outflow of gasses between the bowl to kettle grill insert interface and between the lid to kettle grill insert interface, and wherein the kettle insert wall is a metal material having at least two spaced-apart handles protruding from an exterior surface thereof.

8. A method for redirecting the airflow of a kettle-style grill, comprising:
providing a kettle-style grill, including a kettle bowl and a kettle lid configured to seat onto or within the upper periphery of the kettle bowl, wherein the kettle bowl includes an air inlet in a lower portion of the kettle bowl and wherein the kettle lid includes an air outlet on an upper portion of the kettle lid, and further wherein the kettle bowl is configured to support at least one grill grate within the periphery of the kettle bowl; and
redirecting the airflow of the kettle-style grill by providing a kettle grill insert, the kettle grill insert comprising a wall having a cylindrical geometry, with a lower edge configured to seat onto or within the periphery of the kettle bowl, and an upper edge configured to engage a lower periphery of the kettle lid, wherein the kettle grill insert includes a side exhaust vent configured to draw grill gasses from an area within the kettle lid back down and out of the side of the kettle grill insert.

9. A method in accordance with claim 8, wherein the upper and lower edges of the kettle grill insert include sealing surfaces configured to prevent the outflow of gasses between the bowl to kettle grill insert interface.

10. A method in accordance with claim 8, wherein the side exhaust vent includes an exterior vent pipe with a damper configured to fully open or to restrict the flow of redirected exhaust gasses therethrough and wherein the kettle insert wall is a metal material having at least two spaced-apart handles protruding from an exterior surface thereof.

11. A method in accordance with claim 10, wherein the kettle grill insert further includes at least one grate support surface provided over or above the side exhaust vent at least on the same side as the side exhaust vent.

12. A method in accordance with claim 11, wherein the kettle grill insert is configured with a higher grill grate on the side of the kettle grill insert with the side exhaust vent than the side opposite the kettle grill insert, and wherein redirecting the airflow of the kettle-style grill includes redirecting air at least partially down over the higher grill grate and through the side exhaust vent.

13. A grill insert for a kettle-style grill, comprising:
a wall having a cylindrical geometry, with a lower edge configured to seat onto or within the periphery of a kettle grill bowl and with an upper edge configured to engage a lower periphery of a kettle grill lid, wherein the kettle grill insert includes a side exhaust vent configured to draw grill gasses from an area within the kettle lid back down and out of the side of the kettle grill insert.

14. A grill insert in accordance with claim 13, wherein the side exhaust vent is positioned at least partially through the lower half of the kettle grill insert.

15. A grill insert in accordance with claim 13, wherein the kettle grill insert further includes at least one grate support surface provided over or above the side exhaust vent at least on the same side as the side exhaust vent.

16. A grill insert in accordance with claim 15, wherein the at least one grate support surface is vertically adjustable.

17. A grill insert in accordance with claim 14, wherein the kettle grill insert further includes at least one grate support surface provided on the upper half of the kettle grill insert and at least on the same side of the kettle grill insert as the side exhaust vent.

18. A grill insert in accordance with claim 13, wherein the side exhaust vent includes an exterior vent pipe with a damper.

19. A grill insert in accordance with claim 13, wherein the upper and lower edges of the kettle grill insert include sealing surfaces configured to prevent the outflow of gasses between the bowl to kettle grill insert interface and between the lid to kettle grill insert interface.

20. A grill insert in accordance with claim 19, wherein the sealing surfaces comprise gasket material and wherein the kettle insert wall is a metal material having at least two spaced-apart handles protruding from an exterior surface thereof.
